(19) United States
(12) Patent Application Publication
(10) Pub. No.: US 2026/0332400 A1
(43) Pub. Date: Oct. 22, 2026

(54) SYSTEMS AND METHODS FOR ENTANGLEMENT-CASCADED QUANTUM KEY DISTRIBUTION (QKD)

(71) Applicant: ACCENTURE GLOBAL SOLUTIONS LIMITED, Dublin (IE)

(72) Inventor: Benjamin Glen MCCARTY, Washington, DC (US)

(73) Assignee: ACCENTURE GLOBAL SOLUTIONS LIMITED, Dublin (IE)

(21) Appl. No.: 19/182,267

(22) Filed: Apr. 17, 2025

(51) Int. Cl. H04L 9/08

(52) U.S. Cl. CPC H04L 9/0852; H04L 9/085

(57) ABSTRACT

Systems and methods for entanglement-cascaded quantum key distribution are disclosed. The processor determines set of communication parameters to be transmitted between quantum transmitter and quantum receiver. The processor generates entangled pair of qubits including first set of qubits and second set of qubits. The processor performs first quantum operation associated with first secret key on second qubits of first set of qubits and second set of qubits. The processor swaps second qubit of quantum transmitter with second qubit of receiver. The processor generates entangled qubit pairs by performing quantum entanglement operation on first qubit of quantum transmitter and second qubit of quantum receiver. The processor determines quantum measurement operation to be applied to entangled qubit pairs. The processor performs second quantum operation and generates measurement result for each of entangled qubit pairs. The processor transmits generated shared classical secret key from quantum transmitter to quantum receiver over secure communication channel.

### TECHNICAL FIELD

This patent application is directed to quantum communication systems, and more specifically to, systems and methods for entanglement-cascaded Quantum Key Distribution (QKD).

### BACKGROUND

Quantum Key Distribution (QKD) is a pivotal technology in quantum cryptography, enabling two parties to establish a shared, secret cryptographic key with security grounded in the principles of quantum mechanics. Unlike classical cryptographic methods, QKD theoretically provides unconditional security, as any eavesdropping attempt disrupts the quantum states being exchanged, alerting the communicating parties. QKD systems have been deployed over optical fiber networks and free-space channels, achieving key distribution over large distances. Further, practical QKD implementations may face significant vulnerabilities due to device imperfections and operational constraints. Some QKD protocols depend on classical communication channels for critical functions such as basis reconciliation, error correction, and privacy amplification. For instance, in some QKD protocols, Alice and Bob may compare basis selections via classical messages, creating opportunities for adversarial attacks, including Adversary-in-the-Middle (AITM) scenarios where an attacker impersonates one party or manipulates messages to compromise the key. In turn, the security of QKD may partially hinge on the robustness of these classical channels, which are often less secure than the quantum layer they support.

Physical-layer attacks further exploit deviations between ideal quantum models and real-world systems. These include Photon Number Splitting (PNS) attacks targeting multi-photon pulses, detector blinding attacks using bright light to manipulate detector behavior, fake-state attacks, back-flash attacks, time-shift attacks, phase-remapping attacks, and wavelength-dependent attacks. Attackers may also use high-power lasers to degrade optical components, altering their performance and enabling security breaches. Protocols relying on entangled photon pairs face additional risks such as entanglement-swapping attacks, where an adversary may introduce intermediary entangled states to extract key information. While countermeasures such as decoy states or bidirectional encoding address specific threats, these countermeasures may introduce complexity and new vulnerabilities, such as susceptibility to incoherent attacks or detector control attacks.

Another critical limitation of QKD is transmission distance. Photon loss and signal degradation in optical fibers or free-space channels restrict operational range. Trusted relays or quantum repeaters are commonly employed to extend distance, however, these extenders may introduce security risks, as any compromise at a relay can expose the entire key. This dependency on trusted infrastructure hampers scalability and systemic security. Moreover, many QKD protocols use prepare-and-measure schemes requiring precise synchronization, active participation, and multiple communication rounds for sifting and reconciliation. These operations reduce key generation efficiency and increase exposure to timing-based and side-channel attacks, with evolving protocols often trading one vulnerability for another.

To counter these challenges, advanced techniques such as device-independent QKD, measurement-device-independent QKD (MDI-QKD), wavelength multiplexing, and multi-dimensional encoding have been implemented in the present disclosure. While effective in enhancing security against certain attacks, these approaches significantly increase system complexity, and resource demands, often at the expense of transmission distance. For example, wavelength multiplexing requires precise control of multiple optical wavelengths, complicating system design, while multi-dimensional encoding demands sophisticated modulation and detection, reducing signal fidelity over long ranges. These trade-offs limit the practicality of QKD for widespread deployment, particularly in long-haul fiber networks or satellite-based systems. However, some QKD systems may not ensure robust security against a wide range of attacks, including AITM and physical-layer exploits, without compromising transmission distance or relying on complex technical measures.

Consequently, there may be a need to provide improved systems and methods for entanglement-cascaded quantum key distribution (QKD), and to address at least the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a system for entanglement-cascaded Quantum Key Distribution (QKD). Further, the system may include a quantum transmitter communicatively coupled to the processor. Alternatively, the system may include a quantum transmitter and/or a quantum transducer communicatively coupled to the processor. Further, the processor may determine a set of communication parameters to be transmitted between the quantum transmitter and a quantum receiver by establishing an initial classical communication channel with the quantum receiver. Furthermore, the processor may generate at least one entangled pair of qubits including at least one first set of qubits and at least one second set of qubits based on the determined set of communication parameters. Furthermore, the processor may perform a first quantum operation associated with the first secret key on each of the second qubits of each of the first set of qubits and the second set of qubits. Furthermore, the processor may swap the second qubit of the quantum transmitter with a second qubit of the receiver upon performing the first quantum operation associated with the first secret key at each of the quantum transmitter and the quantum receiver. Furthermore, the processor may generate entangled qubit pairs by performing a quantum entanglement operation on the first qubit of the quantum transmitter and the second qubit of the quantum receiver. Furthermore, the processor may determine at least one quantum measurement operation to be applied to the entangled qubit pairs based on prior measurement results. Furthermore, the processor may perform a second quantum operation associated with the second secret key onto the entangled qubit pairs. Furthermore, the processor may iteratively generate at least one measurement result for each of the entangled qubit pairs until the predetermined number of quantum particles is reached. Furthermore, the processor may generate a shared classical secret key based on the generated at least one measurement result. Furthermore, the processor may transmit the generated shared classical secret key from the quantum transmitter to the quantum receiver over a secure communication channel.

Another aspect of the present disclosure provides a method for entanglement-cascaded quantum key distribution (QKD). Further, the method may include determining a set of communication parameters to be transmitted between the quantum transmitter and a quantum receiver by establishing an initial classical communication channel with the quantum receiver. Alternatively, the method may include determining a set of communication parameters to be transmitted between the quantum transmitter/transducer and a quantum receiver by establishing an initial classical communication channel with the quantum receiver. Furthermore, the method may include generating at least one entangled pair of qubits including at least one first set of qubits and at least one second set of qubits based on the determined set of communication parameters. Furthermore, the method may include performing a first quantum operation associated with the first secret key on each of the second qubits of each of the first set of qubits and the second set of qubits. Furthermore, the method may include swapping the second qubit of the quantum transmitter with a second qubit of the receiver upon performing the first quantum operation associated with the first secret key at each of the quantum transmitter and the quantum receiver. Furthermore, the method may include generating entangled qubit pairs by performing a quantum entanglement operation on the first qubit of the quantum transmitter and the second qubit of the quantum receiver. Furthermore, the method may include determining at least one quantum measurement operation to be applied to the entangled qubit pairs based on prior measurement results. Furthermore, the method may include performing a second quantum operation associated with the second secret key onto the entangled qubit pairs. Furthermore, the method may include iteratively generating at least one measurement result for each of the entangled qubit pairs until the predetermined number of quantum particles is reached. Furthermore, the method may include generating a shared classical secret key based on the generated at least one measurement result. Furthermore, the method may include transmitting the generated shared classical secret key from the quantum transmitter to the quantum receiver over a secure communication channel.

Another aspect of the present disclosure provides a non-transitory computer-readable medium including processor-executable instructions. Further, the processor may determine a set of communication parameters to be transmitted between the quantum transmitter and a quantum receiver by establishing an initial classical communication channel with the quantum receiver. Alternatively, the processor may determine a set of communication parameters to be transmitted between the quantum transmitter/transducer and a quantum receiver by establishing an initial classical communication channel with the quantum receiver. Furthermore, the processor may generate at least one entangled pair of qubits including at least one first set of qubits and at least one second set of qubits based on the determined set of communication parameters. Furthermore, the processor may perform a first quantum operation associated with the first secret key on each of the second qubits of each of the first set of qubits and the second set of qubits. Furthermore, the processor may swap the second qubit of the quantum transmitter with a second qubit of the receiver upon performing the first quantum operation associated with the first secret key at each of the quantum transmitter and the quantum receiver. Furthermore, the processor may generate entangled qubit pairs by performing a quantum entanglement operation on the first qubit of the quantum transmitter and the second qubit of the quantum receiver. Furthermore, the processor may determine at least one quantum measurement operation to be applied to the entangled qubit pairs based on prior measurement results. Furthermore, the processor may perform a second quantum operation associated with the second secret key onto the entangled qubit pairs. Furthermore, the processor may iteratively generate at least one measurement result for each of the entangled qubit pairs until the predetermined number of quantum particles is reached. Furthermore, the processor may generate a shared classical secret key based on the generated at least one measurement result. Furthermore, the processor may transmit the generated shared classical secret key from the quantum transmitter to the quantum receiver over a secure communication channel.

To further clarify the features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

Features of the disclosed embodiments are illustrated by way of example and not limited in the following Figure(s), in which like numerals indicate like elements, in which:

FIGS. 1A and 1B illustrate block diagram representations of network architectures for entanglement-cascaded Quantum Key Distribution (QKD), according to an example.

FIG. 1C illustrates a block diagram representation of a quantum system, which may be implemented in a network architecture shown in FIG. 1A and a network architecture shown in FIG. 1B, for entanglement-cascaded Quantum Key Distribution (QKD), according to an example.

FIG. 2 illustrates a circuit diagram representation of a quantum circuit 200 for entanglement-based quantum key distribution, according to an example.

FIG. 3 illustrates a schematic diagram representation of a quantum communication framework for an entanglement-cascaded Quantum Key Distribution (QKD), according to an example.

FIG. 4 illustrates a flow diagram representation of a method depicting a quantum communication framework including a bidirectional entanglement-based quantum key exchange protocol between two entities, according to an example.

FIG. 5 illustrates a schematic diagram representation of an Entanglement Swapping (ES)-based Quantum Key Distribution (QKD) system architecture between two remote entities, according to an example.

FIG. 6 illustrates a flow diagram representation depicting a method for entanglement-cascaded Quantum Key Distribution (QKD), according to an example.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the examples of the present disclosure so as not to obscure the figures with details that will be readily apparent to those skilled in the art having the benefit of the description herein.

### DETAILED DESCRIPTION

For simplicity and illustrative purposes, the proposed approach and solutions are described by referring mainly to examples and embodiments thereof. In the following description, numerous specific details are set forth in order to provide a thorough understanding of the proposed approach and solutions. It will be readily apparent, however, that the proposed approach and solutions may be practiced without limitation to these specific details. In other instances, some methods and structures readily understood by one of ordinary skill in the art have not been described in detail so as not to unnecessarily obscure the ongoing description. As used herein, the terms “a” and “an” are intended to denote at least one of a particular element, the term “includes” means includes but not limited to, the term “including” means including but not limited to, and the term “based on” means based at least in part on, the term “based upon” means based at least in part upon, and the term “such as” means such as but not limited to. The term “relevant” means closely connected or appropriate to what is being performed or considered.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules.

A computer system (standalone, client, or server computer system) configured by an application may constitute a “module” (or “subsystem”) that is configured and operated to perform certain operations. In one example, the “module” or “subsystem” may be implemented mechanically or electronically, so a module includes dedicated circuitry or logic that is permanently configured (within a special-purpose processor) to perform certain operations. In another example, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Unless otherwise defined, all technical and scientific terms used herein have the same meaning as commonly understood by those skilled in the art to which this disclosure belongs. The system, methods, and examples provided herein are only illustrative and not intended to be limiting.

Examples of the present disclosure provide systems and methods for Quantum Key Distribution (QKD) is described. In the following description, for the purposes of explanation, numerous specific details are set forth to provide a thorough understanding of the present disclosure. It is apparent, however, that the present disclosure may be practiced without these specific details or with an equivalent arrangement. In other instances, well-known structures and devices are shown in block diagram form in order to avoid unnecessarily obscuring the present disclosure.

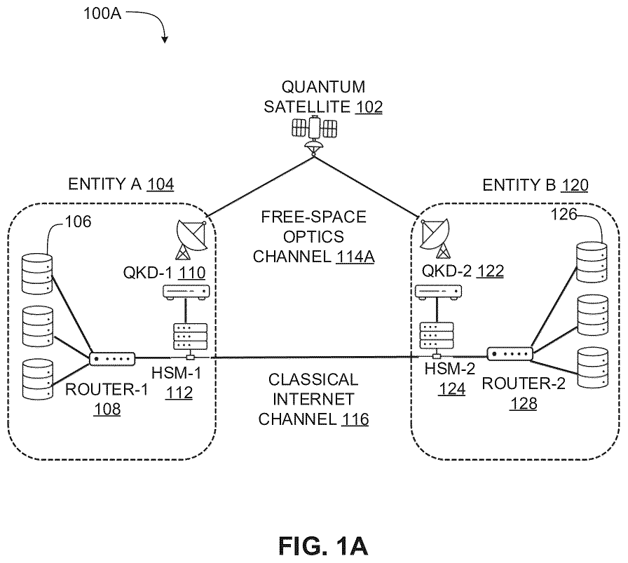

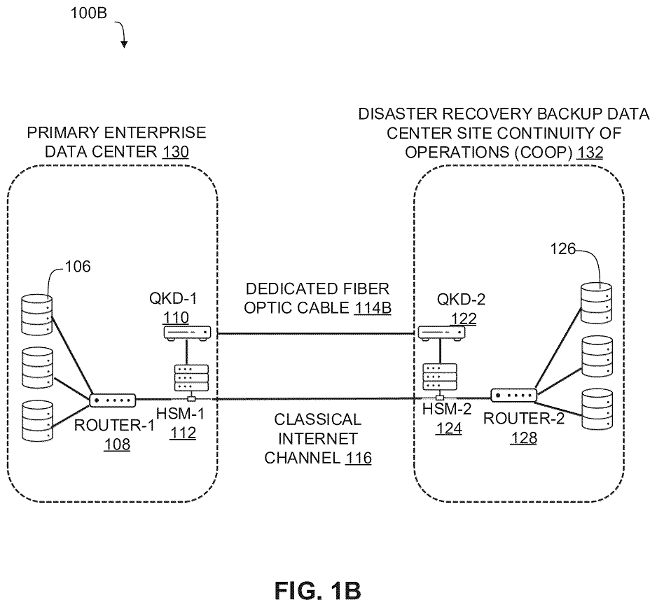

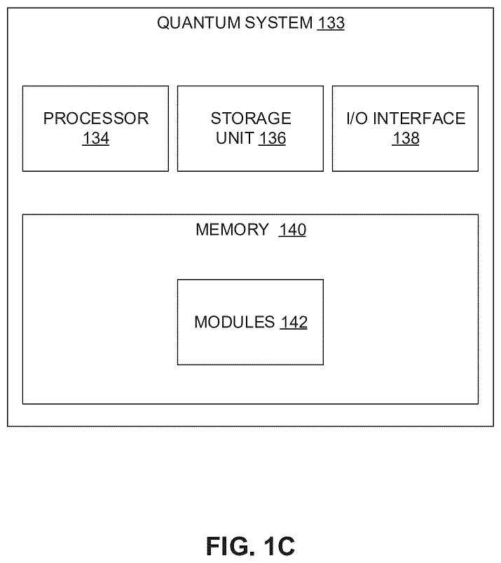

Referring now to the drawings, and more particularly to FIG. 1A through FIG. 6, where similar reference characters denote corresponding features consistently throughout the figures, there are shown preferred examples, and these examples are described in the context of the following exemplary system and/or method.

FIGS. 1A and 1B illustrate block diagram representations of network architectures 100A and 100B for entanglement-cascaded Quantum Key Distribution (QKD), according to an example. FIG. 1A illustrates a block diagram representation of a network architecture 100A for entanglement-cascaded Quantum Key Distribution (QKD). Further, the network architecture 100A depicts, for example, a Quantum Key Distribution (QKD) system. Furthermore, the network architecture 100A may include a quantum satellite 102 to distribute entangled photon pairs to a first entity 104 (herein after referred to as an entity A 104) and a second entity 120 (hereinafter referred to as an entity B 120) via a free-space optics channel 114A. Furthermore, the quantum satellite 102 may operate as an entanglement source node, generating and distributing maximally entangled quantum states simultaneously to both entities for the purpose of secure key establishment. Furthermore, the entity A 104 may include a quantum transmitter 110 optically coupled to receive entangled photons from the quantum satellite 102. Alternatively, the network architecture 100A may include a quantum transmitter and/or a quantum transducer. Furthermore, the quantum transmitter 110 may interface with a transmitter-side router-1 108, which manages the classical and quantum data exchange. Furthermore, the router-1 108 may be connected to a local hardware security module (HSM)-1 112 for cryptographic key storage and protection, and to a data storage cluster-1 106, which may include secure databases, and computing nodes used in conjunction with the QKD process. Furthermore, a classical internet channel 116 may connect the entity A 104 to the entity B 120 for required classical communications supporting QKD protocols.

In the example of the FIG. 1A, the entity B 120 may include a corresponding quantum receiver 122 to detect and process the entangled photons transmitted from the quantum satellite 102. Further, the quantum receiver 122 may be operatively linked to a receiver-side router-2 128, which facilitates communication between the quantum and classical components within the entity B 120. Furthermore, the receiver-side router-2 128 may connect to a hardware security module (HSM)-2 124 and a data storage cluster-2 126 used for secure processing, storage, or authentication services.

In an example, the free-space optical channel 114A may enable entangled photon transmission, while the classical internet channel 116 may facilitate auxiliary processes such as time synchronization, sifting, error correction, and privacy amplification. Furthermore, the classical internet channel 116 may not carry quantum key material directly. Furthermore, the classical internet channel 116 may support classical message exchanges required by QKD protocols to finalize secret key generation without compromising security.

Although certain examples of the present disclosure are described with respect to a Quantum Key Distribution (QKD), the principles and techniques disclosed herein may be applied to other quantum cryptographic protocols or secure communication systems to enhance resilience against adversarial attacks while maintaining practical implementation and transmission distance.

In an example, the Quantum Key Distribution (QKD) method includes receiving entangled quantum states distributed between a first party and a second party via a quantum communication channel. Further, the method includes preparing entangled photon inputs of each party as random, uniformly distributed quantum superpositions. Further, the method includes applying retroactive quantum entanglement operations contingent on prior measurement outcomes stored locally, thereby generating cascaded entangled states. Further, the method may independently measure the resultant entangled states within a local quantum system of each party to yield respective sequences of quantum measurement outcomes. Furthermore, the method may include deriving a first encryption key from the measurement of outcomes of the first party and a second encryption key from the measurement of outcomes of the second party. Further, the method may include conducting reconciliation and tamper detection through retroactive conditional logic, eliminating the need for classical communication exchanges; and delivering the final encryption keys to each party for secure communication.

In an example, the QKD process includes an entanglement-based, device-independent key exchange protocol that operates without classical communication exchanges or prepare-and-measure methodologies. The system utilizes a bidirectional quantum channel to distribute entangled photon pairs between the first and second parties. The quantum system of each party may be configured to prepare photon inputs as randomly selected, uniformly distributed quantum superpositions, chosen independently without mutual coordination. By operating entirely within the quantum domain, the system utilizes quantum uncertainty and the no-cloning theorem to ensure security.

The present disclosure implements a retroactive quantum entanglement mechanism, wherein local systems execute conditional entangling operations post-reception of quantum states, guided by previously stored measurement outcomes. This process creates a cascaded entanglement structure, progressively establishing photon authentication and correlation in a secure manner. The architecture eliminates the necessity for classical synchronization or verification exchanges typically required in certain QKD systems. Within each quantum module in the system, entangled photons are measured against a predefined measurement basis, with outcomes recorded as discrete quantum states. Each system register retains prior measurement data, dynamically utilized for retroactive entanglement operations. Quantum gate operations, such as Hadamard or Controlled-NOT (CNOT) gates, may be executed via conditional logic circuits that reference stored outcomes to determine the entanglement cascade path and characteristics. This conditional processing ensures that the cascaded entanglement remains resistant to tampering and unpredictable to external observers. The entanglement structure is segmented across multiple photon pairs and channels, with each segment processed independently within isolated sub-units. This segmentation enhances system scalability while maintaining robust security. By eliminating intermediate classical reconciliation, the system reduces latency and vulnerability to adversary-in-the-middle or timing-based attacks. The conditional entangling/quantum operations based on the stored measurement outcome of the previous QKD measured bit may be applied agnostically to other QKD protocols such as, but not limited to, Bennett-Brassard 1984 (BB84), Ekert 1991 (E91), and the like, to provide a benefit of entanglement-cascaded protection.

The present disclosure may include, for example, “M” photon interaction units and “N” entanglement modules per segment during cascaded entanglement processing, where each module processes two or more photon pairs and employs stored measurement states as control inputs for retroactive quantum operations. The quantities “M” and “N” may differ, allowing flexibility in entanglement depth and redundancy based on system requirements. Idle states in photon interaction units, arising from timing mismatches or synchronization issues, are managed within the probabilistic framework of the QKD protocol.

The present disclosure may include a QKD system that includes distributed quantum processing with retroactive entanglement logic to securely generate symmetric encryption keys at both parties, inherently integrating tamper detection and entropy validation. In certain embodiments, entangled quantum states are processed through entanglement-preserving quantum repeaters to facilitate long-distance key distribution. Quantum states may originate from, for example, but are not limited to, Bell states, Greenberger-Horne-Zeilinger (GHZ) states, or other maximally entangled pairs, encoded in polarization, time-bin, or other degrees of freedom, and the like. Retroactive gate operations maintain quantum correlations, mitigating decoherence and interception risks. When deployed in scalable quantum networks, the system supports real-time key generation across high-latency links with minimal security compromise.

For example, the entangled quantum states used for key generation are selected from a predefined set of maximally entangled Bell states or GHZ states, each tagged with a quantum identifier and encoded in distinct degrees of freedom, such as, but not limited to, polarization, spatial mode, or time-bin, to ensure compatibility with diverse optical quantum communication systems. Each party, designated as the first quantum node and second quantum node, receives and stores their respective entangled state components in local quantum memory units equipped with temporal buffering to support asynchronous photon reception and storage.

Each party performs quantum measurements on an independently and uniformly randomly chosen local basis, which may include computational, diagonal, or other bases defined within the Hilbert space, subject to application-specific constraints. Measurement outcomes are processed by a retroactive logic module, where conditional quantum operations, such as Hadamard transformations or Controlled-NOT operations, are applied based on the temporal sequence and correlation of prior outcomes. This configuration enables post-measurement entanglement propagation and key derivation, introducing retroactive entanglement authentication.

In an example, the quantum channel (for example, free-space optics channel 114A) may include, but is not limited to, free-space optical paths, fiber-optic links, satellite-ground terminals, depending on operational requirements, combinations thereof, and the like. Quantum repeaters, functioning as intermediary nodes, preserve or enhance entanglement fidelity without accessing key information. These repeaters may perform retroactive entanglement extensions, forming conditional entangled states between non-adjacent nodes through delayed photon entanglement swapping or quantum teleportation techniques.

The present disclosure is applicable across various QKD architectures, including fiber-optic channels, free-space optical links, satellite-to-ground terminals, hybrid configurations, combinations thereof, and the like.

The primary objective of quantum cryptographic systems is to enable secure cryptographic key transmission between distant locations, with security assured by quantum mechanical principles. As depicted in FIG. 1, quantum states, such as entangled photon pairs, may traverse diverse quantum communication infrastructures, including optical fibers, free-space optical links, satellite-based quantum repeaters, or integrated photonic circuits. These systems are engineered to detect eavesdropping or interference through anomalies, ensuring the confidentiality and integrity of distributed keys.

In an example, each quantum node may include exchanging entangled photons over secure quantum channels, configured as a transmitter, receiver, or bidirectional peer, and assigned a unique entangled photon protocol. Upon deployment, entangled state assignments, such as Bell or GHZ states, are dynamically determined based on the node's role, security requirements, and link distance to adjacent nodes.

Unlike some QKD systems requiring classical coordination for synchronization and basis reconciliation, the present protocol embeds synchronization within the quantum entanglement exchange. Mutual intent and basis alignment may be encoded in the entanglement cascade structure and sequence, eliminating classical coordination. Each quantum node maintains a Quantum State Context (QSC), a dynamic profile encompassing physical layer metrics (e.g., entanglement fidelity, photon loss probability), logical layer capabilities (e.g., conditional logic support), and quantum error correction compatibility. Quantum nodes mutually reference respective QSCs during entanglement cascades, using quantum channel signaling with specific entangled state patterns and quantum logic gates to perform peer-to-peer compatibility checks. For example, an initiating node may transmit a Bell state, and the receiving node may apply a Hadamard-CNOT combination to verify compatibility. Mismatches, such as unsupported gate operations or channel decoherence, may be detected through collapsed state analysis without classical communication.

The present disclosure accommodates dynamic or time-dependent quantum resource constraints. A quantum node experiencing high photon buffer utilization or decoherence may temporarily limit cascaded entanglement operations, a condition reflected in its QSC, enabling peer nodes to adapt by simplifying protocols or pausing exchanges until channel conditions improve. Incompatibilities or misalignments in protocol support may be self-detected by the initiating quantum node. For example, if a receiving node cannot perform retroactive entanglement operations, the expected entangled state collapse fails, signaling the limitation without classical diagnostics. This mechanism supports real-time quantum error awareness and operational reconfiguration.

Each quantum node configuration specifies an entanglement generation policy, permissible quantum gate sequences supported by photon types (e.g., polarization, time-bin), and network-level trust anchors (e.g., entanglement path verification). These parameters inform the Quantum Transfer Context (QTC), a unidirectional state machine governing photon entanglement, transformation, and interpretation between node pairs. The QTC is session-specific and unique to each initiator-respondent node pair. The QTC negotiation may be embedded within the entanglement cascade, eliminating classical session keys or control headers. The initiating node tests progressively complex entangled states and gate logic on trial photons until compatibility is confirmed by the measurement outcomes of the receiver. Upon confirmation, a full photon stream adheres to the highest supported fidelity and security level under prevailing channel conditions.

Quantum endpoints may include dedicated quantum routers, user-side quantum network interface cards, satellite-based entangled photon relays, or edge quantum repeaters, interfacing with quantum processing units and memory buffers. These nodes may form mesh or hierarchical trust topologies, tailored to domains such as, but not limited to, defense, telecommunications, finance, and the like. The present disclosure supports asynchronous quantum key exchange through staggered, layered entanglement cascades, enabling nodes to process entangled photons at different times. Post-measurement logic, including error correction and privacy amplification, may be applied asynchronously using encoded gate signatures and measurement outcomes.

In an example, the QKD system implemented in the network architecture 100A may include a quantum transmitter 110 communicatively coupled to the processor (not shown in FIG. 1A). Alternatively, the QKD system implemented in the network architecture 100A may include a quantum transmitter 110 and/or a quantum transducer (not shown) communicatively coupled to the processor. Further, the processor may determine a set of communication parameters to be transmitted between the quantum transmitter 110 and a quantum receiver 122 by establishing an initial classical communication channel with the quantum receiver. Furthermore, the initial classical communication channel may be referred to as classical Internet channel 116. Furthermore, the set of communication parameters may include a first secret key, a second secret key, a synchronization sequence, and a predetermined number of quantum particles. Furthermore, the processor may generate at least one entangled pair of qubits including at least one first set of qubits and at least one second set of qubits based on the determined set of communication parameters. Furthermore, at least one first set of qubits may correspond to the quantum transmitter 110. Furthermore, each of the set of the qubits may include a first qubit and a second qubit. Furthermore, the processor may perform a first quantum operation associated with the first secret key on each of the second qubits of each of the first set of qubits and the second set of qubits. Furthermore, the processor may swap the second qubit of the quantum transmitter 110 with a second qubit of the quantum receiver 122 upon performing the first quantum operation associated with the first secret key at each of the quantum transmitter 110 and the quantum receiver 122. Furthermore, the second qubit of the quantum receiver 122 may correspond to the at least one second set of qubits generated by the quantum receiver 122.

Furthermore, the processor may generate entangled qubit pairs by performing a quantum entanglement operation on the first qubit of the quantum transmitter 110 and the second qubit of the quantum receiver 122. Furthermore, the quantum entanglement operation may establish a maximally entangled bipartite state. Furthermore, the processor may determine at least one quantum measurement operation to be applied to the entangled qubit pairs based on prior measurement results. Furthermore, the at least one quantum measurement operation may include at least one controlled quantum gate operation. Furthermore, the processor may perform a second quantum operation associated with the second secret key onto the entangled qubit pairs. Furthermore, the processor may iteratively generate at least one measurement result for each of the entangled qubit pairs until the predetermined number of quantum particles is reached. Furthermore, at least one measurement result may be generated by measuring the entangled qubit pairs using the determined at least one quantum measurement operation. Furthermore, the determined at least one quantum measurement operation may orientate a state of the entangled qubit pairs to a predefined quantum measurement basis before transmission. Furthermore, the processor may generate a shared classical secret key based on the generated at least one measurement result. Furthermore, the processor may transmit the generated shared classical secret key from the quantum transmitter 110 to the quantum receiver 122 over a secure communication channel.

In the present entanglement-cascaded Quantum Key Distribution (QKD) network architecture 100A, each quantum node may be represented by the entity A 104 and the entity B 120, which may include a quantum transmitter 110, a quantum receiver 122, a transmitter-side router-1 108, a receiver-side router-2 128, a secure storage, and a communication infrastructure. These nodes are operatively connected via both a free-space optics channel 114A, linking to a quantum satellite 102, and a classical internet channel 116.

The entity A 104, for example, includes a quantum transmitter 110, a router-1 108, a data storage cluster-1 106, and a hardware security module (HSM)-1 112. Further, the entity B 120 similarly includes a quantum receiver 122, a receiver-side router-2 128, a data storage cluster-2 126, and an HSM-2 124. The configuration of these components allows for secure quantum entanglement initialization, transmission, and verification, with cryptographic key generation occurring without classical synchronization.

Some QKD approaches depend on classical coordination channels for basis reconciliation and entanglement synchronization. In contrast, the present network architecture 100A embeds synchronization directly into the entanglement process. The quantum transmitter 110 in the entity A 104 sends entangled photons to the quantum receiver 122 at the entity B 120 via the quantum satellite 102 over the free-space optics channel 114A. For example, no classical backchannel may be required, as mutual quantum states and basis alignment are encoded directly into the structure of the entangled states.

Each quantum entity maintains a Quantum State Context (QSC), which is a dynamically updated operational profile capturing readiness parameters such as, but not limited to, photon coherence, gate operation compatibility, a Quantum Error Correction (QEC) capability, an entanglement fidelity, and the like. During transmission, the QSCs between entity A 104 and the entity B 120 may be implicitly compared via entangled state operations and measurement outcomes, removing the need for classical state negotiation.

For example, the quantum transmitter 110 may generate a Bell state and perform a Hadamard operation before emitting the entangled photon to the quantum satellite 102. The quantum satellite 102 may relay the photon to the quantum receiver 122 at the entity B 120, which applies a conditional gate sequence such as, but not limited to, a CNOT or a Bell-state projection, and the like. The successful collapse of the expected state confirms protocol alignment and channel integrity.

The network architecture 100A may be resilient to varying quantum load conditions. The hardware security module HSM-1 112 and the router-1 108 at the entity A 104 may manage data flow and quantum buffer constraints. If quantum resources are over-utilized, for example, due to photon memory saturation or temporal decoherence, the network architecture 100A may adaptively switches to less resource-intensive entanglement protocols or delays transmission until optimal conditions resume.

Self-diagnosis of incompatibilities may be enabled at the transmission side. If, for example, the entity B 120 may lack support for retroactive entanglement validation or advanced logic gates, this deficiency may be detected by the entity A 104 through failure in entanglement confirmation. Such diagnostics are embedded within the quantum measurement outcomes, making classical debugging unnecessary.

Each entity maintains a configurable Quantum Transfer Context (QTC), which includes, but not limited to, entanglement policy, gate operation sequences, photon encoding types (for example, polarization, time-bin), trust anchors, and the like. The configurable QTC may be encoded and evaluated during each QKD session. The HSM-1 112, and HSM-2 124 may perform critical roles in securing the resulting keys and interfacing with one or more downstream cryptographic systems.

The QTC setup may be performed entirely within the entanglement exchange process. Trial entanglements with increasing complexity may be initiated by the entity A 104 via the transmitter 110, while the entity B 120 may perform corresponding evaluations using the receiver 122. When an established mutual compatibility is a full-scale entangled photon stream transmitted via the satellite 102, the network architecture 100A ensures maximum security and integrity under the prevailing channel conditions.

Quantum endpoints, including the quantum satellite 102 and both on-ground entities such as the entity A 104, and the entity B 120, may include advanced components such as the transmitter-side router-1 108, and the receiver-side router-2 128, quantum-capable NICs, quantum memory interfaces, and the like. The quantum satellite 102 may function as an entangled photon relay and may also perform entanglement swapping operations in a satellite-to-ground mode or an inter-satellite mode.

The network architecture 100A may support asynchronous entanglement cascades, where the entity A and the entity B may initiate or respond to photon transmissions at staggered intervals. The use of a retroactive gate application, a buffered quantum memory, and a photon position encoding allows for non-synchronized key generation without loss of security or fidelity. To counter timing discrepancies, each transmitted photon may include an entanglement signature such as a unique encoding of the respective role within the entangled sequence. This enables the entity B 120 to apply corrective or compensatory logic using the receiver-side router-2 128 and the HSM-2 124 to recover the intended key segment or flag it for exclusion, enhancing robustness against jitter and decoherence.

For example, the quantum transmitter 110 at the entity A 104 may send a Bell state |Φ⁺> at time T₀ via the quantum satellite 102. The quantum receiver 122 at the entity B 120, upon receiving the photon at a later time T₁, performs entanglement verification logic and confirms fidelity. The HSM-2 124 then commits the key bits to the data storage cluster-2 126. Any inconsistencies detected through the quantum correlation mismatches may be flagged and excluded, ensuring precisely high-integrity keys are used. The network architecture 100A may extensively use quantum logic operations, particularly the Hadamard and Controlled-NOT (CNOT) gates, to generate and manipulate entangled quantum states used in the secure key distribution process. These gates are fundamental in creating the cascaded entanglement effect and ensuring quantum coherence across distributed nodes, all without relying on classical communication for synchronization.

Further, the Hadamard gate may be first applied to an initialized qubit at the quantum transmitter in the entity A 104. This gate transforms the qubit from a definite state into a superposition state, essentially introducing quantum uncertainty that is essential for generating entanglement. By placing the qubit in a probabilistic mixture of states, it enables the quantum system to later demonstrate correlations that cannot be explained classically.

Following this, the Controlled-NOT (CNOT) gate may be applied to a pair of qubits. One qubit acts as the control, and the other as the target. The effect of this operation is to entangle the two qubits, such that the state of one instantly affects the state of the other. This sequence of a Hadamard gate may be followed by a CNOT gate to create a maximally entangled pair of qubits, which can then be physically separated and transmitted over quantum channels, such as those facilitated by a satellite-based optical link.

At the quantum receiver 122, the entity B 120 may mirror the operations by applying own sequence of quantum gates of the entity B, beginning with a CNOT operation, and followed by a Hadamard gate on the received qubit and a local reference qubit. After this sequence, the network architecture 100A may perform quantum measurements. If the expected entangled correlation patterns are observed, then patterns confirms that the transmission may be secure, and the quantum state remained unaltered during transit. This acts as a quantum verification mechanism, ensuring that both parties share the same quantum state and hence, the same secure key material.

FIG. 1B illustrates a block diagram representation of a network architecture 100B for entanglement-cascaded Quantum Key Distribution (QKD), according to an example. Further, the network architecture 100B depicts another Quantum Key Distribution (QKD) system. Furthermore, the network architecture 100B may include the quantum satellite 102 (not shown in FIG. 1B, and as shown in FIG. 1A) to distribute entangled photon pairs to a primary enterprise data center 130, similar to the first entity 104 (Entity A) shown in FIG. 1A, and a disaster recovery backup data center site Continuity of Operations (COOP) 132, similar to the second entity 120 (Entity B) shown in FIG. 1A, via a dedicated fiber optic cable 114B, similar to the free-space optics channel 114 as shown in FIG. 1A. Furthermore, the quantum satellite 102 may operate as an entanglement source node, generating and distributing maximally entangled quantum states simultaneously to both entities for the purpose of secure key establishment. Furthermore, the primary enterprise data center 130 may include a quantum transmitter 110 optically coupled to receive entangled photons from the quantum satellite 102. Furthermore, the quantum transmitter 110 may interface with a transmitter-side router-1 108, which may manage the classical and quantum data exchange. Furthermore, the transmitter-side router-1 108 may be connected to a local hardware security module (HSM)-1 112 for a cryptographic key storage and protection, and to a data storage cluster-1 106, which may include secure databases, computing nodes used in conjunction with the QKD process. Furthermore, a classical internet channel 116 may connect to the primary enterprise data center 130 to the disaster recovery backup data center site COOP 132 for required classical communications supporting QKD protocols.

In the example of the FIG. 1B, disaster recovery backup data center site 132 may include a corresponding quantum receiver-2 122 to detect and process the entangled photons transmitted from the quantum satellite 102. Further, the quantum receiver 122 may be operatively linked to a receiver-side router-2 128, which facilitates communication between the quantum and classical components within the disaster recovery backup data center site COOP 132. Furthermore, the receiver-side router-2 128 may connect to a hardware security module (HSM)-2 124 and a data storage cluster-2 126 used for secure processing, storage, authentication services, and the like.

In an example, the dedicated fiber optic channel 114B may enable entangled photon transmission, while the classical internet channel 116 may facilitate auxiliary processes such as time synchronization, sifting, error correction, and privacy amplification. Furthermore, the classical internet channel 116 may not carry quantum key material directly. Furthermore, the classical internet channel 116 may support classical message exchanges required by QKD protocols to finalize secret key generation without compromising security.

FIG. 1C illustrates a block diagram representation of a quantum system 133, which may be implemented in the network architecture 100A shown in FIG. 1A and the network architecture 100B shown in FIG. 1B, for entanglement-cascaded quantum key distribution (QKD), according to an example. In an example, the quantum system 133 may include a processor 134, a storage unit 136, an Input/Output (I/O) interface 138, and a memory 140. Further, the memory 140 may include a plurality of modules 142.

In an example, the processor 134 may be communicatively coupled to the quantum transmitter 110 and/or the quantum receiver 122. Furthermore, the processor 134 may determine a set of communication parameters to be transmitted between the quantum transmitter 110 and a quantum receiver 122 by establishing an initial classical communication channel such as the classical internet channel 116 (interchangeably referred hereinafter to as the initial classical communication channel or the classical internet channel 116) with the quantum receiver 122. Furthermore, the set of communication parameters may include, but is not limited to, a first secret key, a second secret key, a synchronization sequence, a predetermined number of quantum particles, and the like.

Furthermore, the processor 134 may generate at least one entangled pair of qubits including at least one first set of qubits and at least one second set of qubits based on the determined set of communication parameters. Furthermore, the at least one first set of qubits may correspond to the quantum transmitter 110. Furthermore, each of the set of the qubits may include a first qubit and a second qubit.

In an example, the processor 134 may determine a quantum operation to be applied to the second qubits of each of the first set of qubits and the second set of qubits before performing the at least one quantum measurement operation. Further, the quantum operation may include, but not limited to, a controlled-Hadamard gate, a controlled-NOT (CNOT) gate, and the like. Furthermore, the quantum operation may include, but not limited to, a dynamic phase-shift adjustment, determined based on the first secret key, and the like. Furthermore, the processor 134 may conditionally apply the determined quantum operation on each of the second qubits of each of the first set of qubits and the second set of qubits based on last stored classical measurement results. The determined quantum operation is conditionally applied on each of the second qubits of each of the first set of qubits and the second set of qubits used in a plurality of Quantum Key Distribution (QKD) protocols for an entanglement-cascaded protection. Furthermore, the processor 134 may perform a first quantum operation associated with the first secret key on each of the second qubits of each of the first set of qubits and the second set of qubits. Furthermore, the processor 134 may verify the completion of the first quantum operation by detecting the coherence properties of modified second qubits.

In an example, the processor 134 may swap the second qubit of the quantum transmitter 110 with a second qubit of the quantum receiver 122 upon performing the first quantum operation associated with the first secret key at each of the quantum transmitter 110 and the quantum receiver 122. Further, the second qubit of the quantum receiver 122 may correspond to the at least one second set of qubits generated by the quantum receiver 122.

In an example, the processor 134 may generate entangled qubit pairs by performing a quantum entanglement operation on the first qubit of the quantum transmitter 110 and the second qubit of the quantum receiver 122. Further, the quantum entanglement operation may establish a maximally entangled bipartite state. Furthermore, the processor 134 may perform a sequence of conditional quantum measurement operations on the entangled qubit pairs. Each of the measurement operation may be performed at a predefined step in the synchronization sequence. Furthermore, at least one quantum measurement operation may include an operation performed in a defined measurement basis. Furthermore, the defined measurement basis may include, but not limited to, an X-basis measurement, a Y-basis measurement, a Z-basis measurement, and the like. Furthermore, the processor 134 may determine at least one quantum measurement operation to be applied to the entangled qubit pairs based on prior measurement results. Furthermore, the at least one quantum measurement operation may include at least one controlled quantum gate operation. Furthermore, the processor 134 may perform a second quantum operation associated with the second secret key onto the entangled qubit pairs.

In an example, the processor 134 may perform a quantum state verification process by comparing the generated at least one measurement result with a plurality of prior photon exchanges. Further, the processor 134 may identify at least one inconsistency in each of the generated at least one measurement result. Furthermore, the at least one inconsistency being indicative of at least one of transmission errors and an external interference. Furthermore, the processor 134 may generate at least one synchronization parameter to coordinate sequential quantum exchanges between the quantum transmitter 110 and the quantum receiver 122. Furthermore, the processor 134 may apply the prior measurement results as conditional inputs for performing subsequent quantum measurement operations on the entangled qubit pairs. Furthermore, the processor 134 may repeat the process of entanglement, transmission, and measurement operations iteratively until the predetermined number of quantum particles are reached. Furthermore, the processor 134 may iteratively generate at least one measurement result for each of the entangled qubit pairs until the predetermined number of quantum particles reached. Furthermore, the at least one measurement result may be generated by measuring the entangled qubit pairs using the determined at least one quantum measurement operation. Furthermore, the determined at least one quantum measurement operation may orientate a state of the entangled qubit pairs to a predefined quantum measurement basis before transmission.

In an example, the processor 134 may determine an entanglement cascade sequence of the entangled qubit pairs by dynamically adjusting quantum operations based on prior measurement results. Further, the processor 134 may dynamically adjust a quantum measurement basis in response to the prior measurement results from prior photon exchanges. Furthermore, the processor 134 may perform the conditional quantum gate operations using a conditional logic function based on the prior measurement results. Further, the processor 134 may apply conditional quantum gate operations on the entangled qubit pairs based on the determined entanglement cascade sequence to generate accumulated measurement results. Furthermore, the processor 134 may generate a shared classical secret key based on the generated at least one measurement result. Furthermore, the processor 134 may transmit the generated shared classical secret key from the quantum transmitter 110 to the quantum receiver 122 over a secure communication channel. Furthermore, the quantum receiver 122 associated with the processor 134 may reconstruct the shared classical secret key by concatenating the prior measurement results based on the communication parameters.

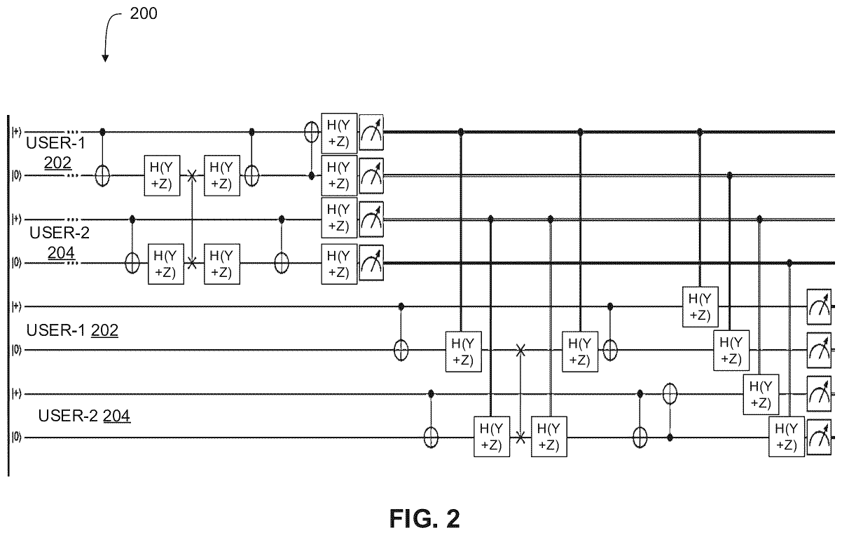

FIG. 2 illustrates a circuit diagram representation of a quantum circuit 200 for entanglement-based quantum key distribution, according to an example. In an example, the quantum circuit 200 may implement a sequence of entanglement operations between quantum registers associated with a user-1 202 and a user-2 204. Furthermore, the quantum circuit 200 may include a set of qubit lines. Furthermore, each qubit may be initialized in the ground state |0>. Furthermore, the user-1 202 and user-2 204 may independently prepare a standard entangled bell pair on the register. Furthermore, the selected qubits may be subjected to Hadamard (H) gates to place the qubits into a superposition state. Furthermore, the superposed qubits may be entangled via a plurality of Controlled-NOT (CNOT) gates operating across qubit lines belonging to user-1 202 and user-2 204, which further forming bipartite entangled states. Furthermore, the entangled states span multiple registers and may be dimension-4 in nature, with controlled logic applied between specific qubit lines. Furthermore, before and after entanglement-swapping, a first cryptographic key (for example, “key1”) agreed during bootstrap applied by both user-1 202 and user-2 204 to second qubit in each entangled pair, respectively. Furthermore, the qubits may be swapped between user-1 202 and user-2 204, after which a maximal entanglement operation performed. Furthermore, the quantum operations may be arranged such that specific pairs of qubits from user-1 202 and user-2 204 mutually entangled using gate operations applied in a defined temporal and spatial sequence.

In another example, additional quantum gates, including controlled unitary operations and swap gates, may be applied to propagate entanglement and transfer state information between multiple sets of qubits. Further, the operations may be structured to implement a cascade configuration, further operations on one register influence operations on subsequent registers via controlled interactions. Furthermore, a measurement bonding strategy may be employed, further at least one of user-1 202 and user-2 204 may measure first and may share the temporal order based on a pre-agreed sequence synchronization, ensuring that both user-1 202 and user-2 204 maintain order during the process. Furthermore, the qubits from the first stage of entanglement may be used as controls in subsequent operations, establishing logical dependencies within the quantum circuit 200. Furthermore, a set of quantum measurement operations may be applied at the end of the quantum circuit 200. Furthermore, each qubit line terminates with a measurement gate to project the quantum state onto a computational basis. Furthermore, the quantum circuit 200 may include measurement for all qubits associated with both user-1 202 and user-2 204. Furthermore, a second cryptographic key (for example, “key2”) may be applied to each qubit just before final measurement. Furthermore, the final measurement outcomes may be determined by the prior entanglement and gate operations executed within the quantum circuit 200. Furthermore, the measured outputs of user-1 202 may be expected to match measured outputs of user-2 204 for each entangled qubit pair across the 2-bit combinations. Furthermore, the quantum circuit 200 may include configuration of layered entanglement and controlled operations extending across at least two rounds of interaction, each involving a respective quantum register for user-1 202 and user-2 204. Furthermore, a symmetry may be maintained across a plurality of exchanges by conditioning the application of the key1 and the key2 in each round based on the prior measurement results. Furthermore, a depicted configuration of the circuit diagram 200 may include a layered entanglement and controlled operations extending across at least two rounds of interaction, each involving a respective quantum register for user-1 202 and user-2 204. Furthermore, the aforementioned process may be repeated iteratively for a pre-agreed number of photons, with each round dynamically adapting the keys and logic gates based on the evolving history of previous round results.

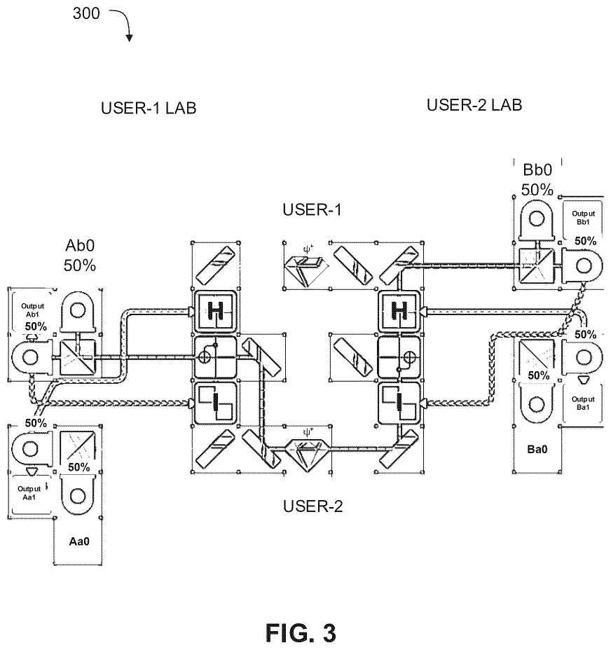

FIG. 3 illustrates representative schematic diagram of a quantum communication framework 300 for entanglement-cascaded Quantum Key Distribution (QKD), according to an example. In an example, both user-1 202 and user-2 204 may independently prepare a first entangled photon pair, denoted as ‘Ψ’, generated using a standard spontaneous parametric down-conversion or equivalent photon-pair generation techniques. Further, the photons may be spatially separated, with one photon retained locally while the other routed toward the remote user via a low-loss photonic quantum channel. Furthermore, at the entanglement cascading region, the incoming photons from the user-1 202 and the user-2 204 may be recombined using a network of polarization-maintaining beam splitters and path-interference filters. Further, the region may include a series of photonic logic gates, including one or more Hadamard gates (H), one or more Controlled-NOT (CNOT) gates, and one or more identity (I) gates implemented in one or more integrated optics. Furthermore, the photonic logic gates may be applied conditionally based on the outcomes of initial photon measurements. Furthermore, the gate-selection logic may be passively enforced via optical routing, without requiring active or classical feedback mechanisms. Furthermore, the site of user-1 202 and user-2 204 may include two distinct detection subsystems, labeled Aa0, Aa1 for the user-1 202 and Ba0, Ba1 for the user-2 204, each with beam splitters operating at, for example, 50% probability. Furthermore, the beam splitters may direct the photons to at least one of single-photon avalanche detectors, and equivalent quantum photodetectors. Furthermore, the detection events may be registered as raw key material.

In an example, the symmetry of the entanglement cascade, in conjunction with the gate-conditioned photon interference may ensure the measurement outcomes at user-1 202 and user-2 204 deterministically correlated. Further, the correlation may be preserved without the need for classical communication or sifting, as required in some QKD protocols. Furthermore, the QKD protocol may satisfy device-independent security constraints and supports post-quantum adversarial resilience through respective nonlocal entanglement verification subroutine.

In an example, the final output measurement results, such as captured at detectors Ab0/Ab1 and Bb0/Bb1, yield matching quantum bits for each entangled event, which further allow user-1 202 and user-2 204 to derive a shared secret key. Furthermore, the results may be obtained with high fidelity due to the integrity of the entanglement-swapping logic and retroactively applied conditional gates, which further enforce strict quantum state alignment regardless of transmission order or timing jitter.

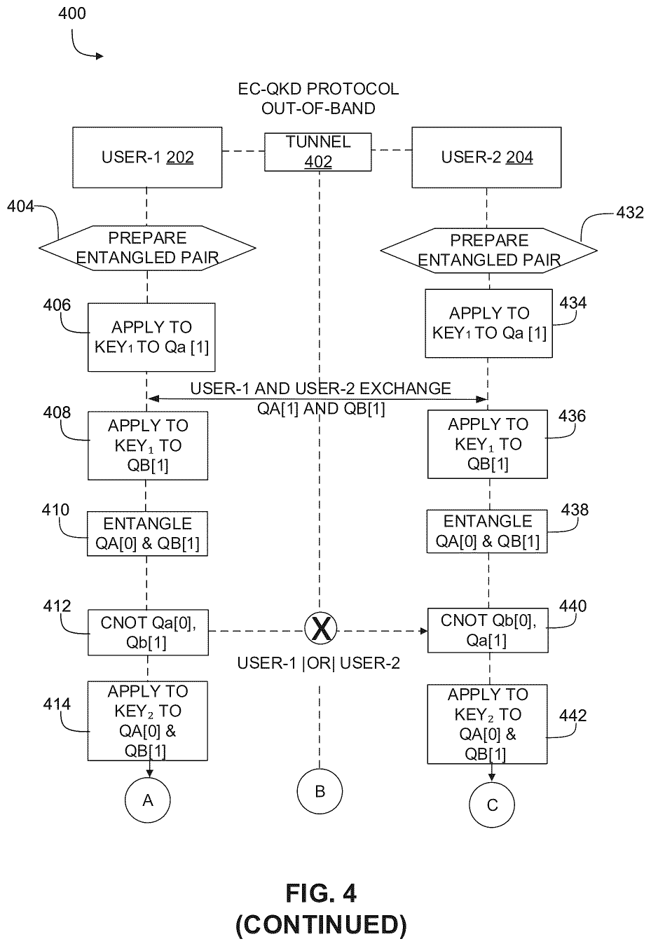

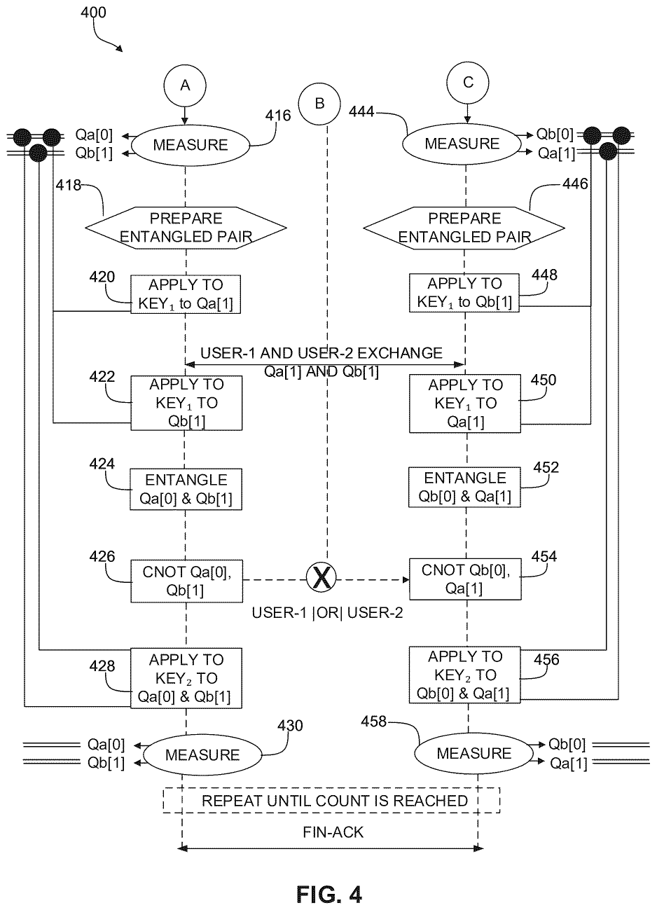

FIG. 4 illustrates a flow diagram representation of a method 400 depicting a quantum communication framework including a bidirectional entanglement-based quantum key exchange protocol between two entities, according to an example. In an example, the method 400 includes exchanging, by the processor 134, bootstrap between a user-1 202 and a user-2 204 via a tunnel 402. Further, both the user-1 202, and user-2 204 nodes negotiate and agree upon a first cryptographic key (Key1), a second cryptographic key (Key2), a photon exchange repetition count, and a synchronization order for sequence control of entangled photon cycles.

At step 404, the method 400 includes preparing, by the processor 134, the user-1 202, an entangled Bell pair including qubits Qa[0] and Qb[1]. Simultaneously, at step 432, the method 400 includes preparing, by the processor 134, the user-2 204, an entangled Bell pair including qubits Qa[1] and Qb[0].

At step 406, the method 400 includes applying, by the processor 134, Key₁ to Qa[1] by the first user 202 before transmission. Similarly, at step 434, the method includes applying, by the processor 134, Key₁ to Qb[1] by the user-2 204. Further, the method 400 includes exchanging Qa[1] and Qb[1] in between the user-1 202 and the user-2 204.

At step 408, the method 400 includes applying, by the processor 134, Key₁ to Qb[1] by the user-1 202 before transmission. Similarly, at step 436, the method 400 includes applying Key₁ to Qa[1] by the user-2 204.

At step 410, the method 400 includes entangling, by the processor 134, Qa[0] with the received Qb[1] by the user-1 202. Similarly, at step 438, the method includes entangling, by the processor 134, Qb[0] with the received Qa[1] by the user-2 204.

At step 412, the method 400 includes applying, by the processor 134, a CNOT gate in between Qa[0] and Qb[1] at the user-1 202. Similarly, at step 440, the method includes applying, by the processor 134, a CNOT gate in between Qb[0] and Qa[1] at the user-2 204.

At step 414, the method 400 includes applying, by the processor 134, Key₂ to Qa[0] and Qb[1] by the user-1 202 before transmission. Similarly, at step 442, the method 400 includes applying, by the processor 134, Key₂ to Qb[0] and Qa[1] by the user-2 204.

At step 416, the method 400 includes performing, by the processor 134, a local quantum measurement at user-1 202 location to derive a shared intermediate quantum state. Similarly, at step 444, the method 400 includes performing, by the processor 134, a local quantum measurement at user-2 204 location to derive a shared intermediate quantum state.

At step 418, the method 400 includes preparing, by the processor 134, the user-1 202, a new entangled Bell pair for the next sequence count index. Simultaneously, at step 432, the method 400 includes preparing, by the processor 134, the user-2 204, a new entangled Bell pair for the next sequence count index.

At step 420, the method 400 includes applying, by the processor 134, Key₁ to Qa[1] by the first user 202 before transmission. Similarly, at step 448, the method includes applying, by the processor 134, Key₁ to Qb[1] by the user-2 204. Further, the method 400 includes exchanging Qa[1] and Qb[1] in between user-1 202 and user-2 204.

At step 422, the method 400 includes applying, by the processor 134, Key₁ to Qb[1] by the user-1 202 before transmission. Similarly, at step 450, the method 400 includes applying Key₁ to Qa[1] by the user-2 204.

At step 424, the method 400 includes entangling, by the processor 134, Qa[0] with the received Qb[1] by the user-1 202. Similarly, at step 452, the method includes entangling, by the processor 134, Qb[0] with the received Qa[1] by the user-2 204.

At step 426, the method 400 includes applying, by the processor 134, a CNOT gate in between Qa[0] and Qb[1] at the user-1 202. Similarly, at step 454, the method includes applying, by the processor 134, a CNOT gate in between Qb[0] and Qa[1] at the user-2 204.

At step 428, the method 400 includes applying, by the processor 134, Key₂ to Qa[0] and Qb[1] by the user-1 202 before transmission. Similarly, at step 456, the method 400 includes applying Key₂ to Qb[0] and Qa[1] by the user-2 204.

At step 430, the method 400 includes performing, by the processor 134, a local quantum measurement at user-1 202 location to derive a shared intermediate quantum state. Similarly, at step 458, the method 400 includes performing, by the processor 134, a local quantum measurement at user-2 204 location to derive a shared intermediate quantum state.

Further, the method 400 includes verifying whether the agreed photon count threshold has been reached. If not, the process loops back to step 404 and 432. Once complete, a FIN-ACK acknowledgment may be optionally performed to ensure full state synchronization. Furthermore, the resulting classical bit sequences obtained by the user-1 202 and the user-2 204 may securely correlated and constitute a symmetric, cryptographically secure shared secret, suitable for use in One-Time Pad (OTP) schemes or for deriving session keys using Key-Derivation Functions (KDF).

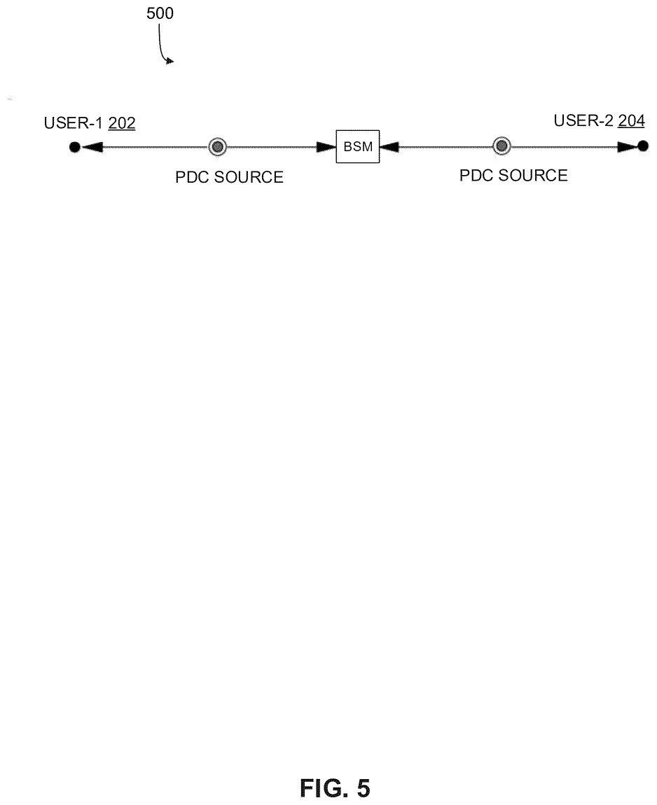

FIG. 5 illustrates a schematic diagram representation of an Entanglement Swapping (ES)-based Quantum Key Distribution (QKD) architecture 500 between two remote entities, according to an example. In an example, user-1 202 and user-2 202 may generate entangled photon pairs via one or more independent Parametric Down-Conversion (PDC) sources, sending one photon to a central Bell-State Measurement (BSM) node. Further, the user-1 202 and the user-2 204 may precisely measure one photon locally. Furthermore, the entanglement between the user-1 202 and the user-2 204 may be established conditionally through a successful BSM at the midpoint. However, the setup may require classical communication for basis reconciliation, further user-1 202 and user-2 204 may reveal chosen polarization bases (for example, horizontal, vertical, or diagonal) to sift matching results for key generation.

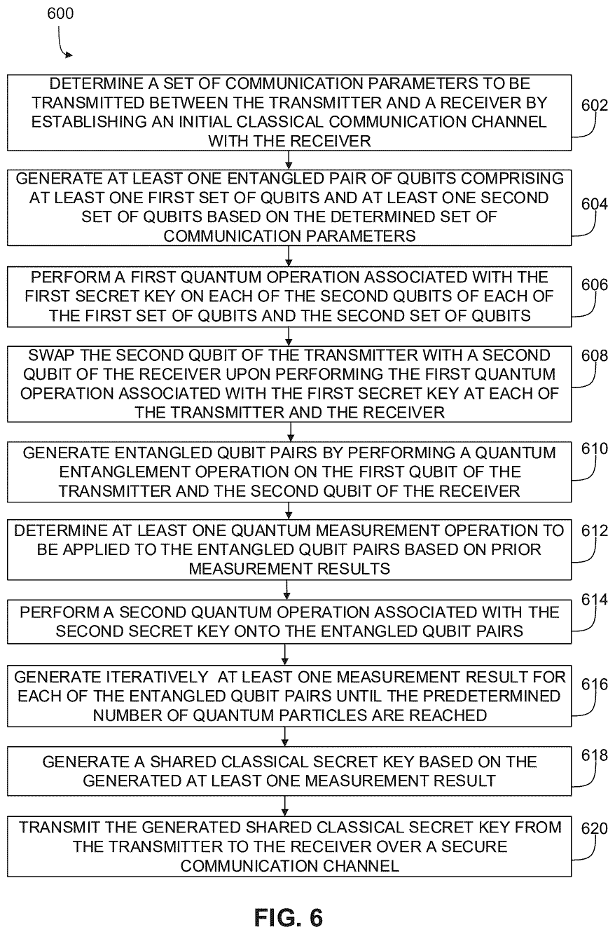

FIG. 6 illustrates a flow diagram representation depicting a method 600 for entanglement-cascaded quantum key distribution (QKD), according to an example.

At step 602, the method 600 includes determining, by the processor 134, a set of communication parameters to be exchanged with a quantum receiver 122 by establishing an initial classical communication channel with the quantum receiver 122. Further, the set of communication parameters may include a first secret key, a second secret key, a synchronization sequence, and a predetermined number of quantum particles to be transmitted.

At step 604, the method 600 includes generating, by the processor 134, at least one entangled pair of qubits including a first set of qubits, and a second set of qubits based on the determined set of communication parameters. Further, the at least one first set of qubits may correspond to the quantum transmitter 110 and the at least one second set of qubits may correspond to the quantum receiver 122. Furthermore, each set may include a first qubit and a second qubit.

At step 606, the method 600 includes performing, by the processor 134, a first quantum operation associated with the first secret key on each second qubit in the first set and the second set of qubits.

At step 608, the method 600 includes swapping, by the processor 134, the second qubit of the quantum transmitter 110 with a second qubit of the quantum receiver 122 upon performing the first quantum operation associated with the first secret key at each of the quantum transmitter 110 and the quantum receiver 122. Further, the second qubit of the quantum receiver 122 may correspond to the at least one second set of qubits generated by the quantum receiver 122.

At step 610, the method 600 includes generating, by the processor 134, entangled qubit pairs by performing a quantum entanglement operation to the first qubit of the quantum transmitter 110 and the second qubit of the quantum receiver 122 Further, the quantum entanglement operation may establish a maximally entangled bipartite state.

At step 612, the method 600 includes determining, by the processor 134, at least one quantum measurement operation to be applied to the entangled qubit pairs based on prior measurement results. In an example, the at least one quantum measurement operation may include at least one controlled quantum gate operation, such as a Controlled-NOT (CNOT) or conditional Hadamard (H) gate.

At step 614, the method 600 includes performing, by the processor 134, a second quantum operation associated with the second secret key onto the entangled qubit pairs.

At step 616, the method 600 includes iteratively generating, by the processor 134, at least one measurement result for each of the entangled qubit pairs until the predetermined number of quantum particles reached. Further, the at least one measurement result may be generated by measuring the entangled qubit pairs using the determined at least one quantum measurement operation. Furthermore, the determined at least one quantum measurement operation may orientate a state of the entangled qubit pairs to a predefined quantum measurement basis before transmission.

At step 618, the method 600 includes generating, by the processor 134, a shared classical secret key based on the at least one measurement results derived from the entangled qubit pairs.

At step 620, the method 600 includes transmitting, by the processor 134, the generated shared classical secret key from the quantum transmitter 110 to the quantum receiver 122 over a secure communication channel referred to as classical internet channel 116.

The order in which the method 600 is described is not intended to be construed as a limitation, and any number of the described method blocks may be combined or otherwise performed in any order to implement the method 600 or an alternate method. Additionally, individual blocks may be deleted from the method 600 without departing from the spirit and scope of the ongoing description. Furthermore, the method 600 may be implemented in any suitable hardware, software, firmware, or a combination thereof, that exists in the related art or that is later developed. The method 600 describes, without limitation, the implementation of the quantum system 133 or the network architecture 100A or the network architecture 100B. A person of skill in the art will understand that method 600 may be modified appropriately for implementation in various manners without departing from the scope and spirit of the ongoing description.

Various examples of the present disclosure provide systems and methods for entanglement-cascaded quantum key distribution. Further, the present QKD protocol uses bootstrap key agreement, iterative conditional operations, and maximally entangled bipartite states to enable secure, high-fidelity classical key generation over quantum channels. By optimizing the sequencing of key-dependent quantum operations and reducing the requirement for real-time basis reconciliation, the present disclosure mitigates susceptibility to eavesdropping attacks and increases resistance to channel noise. Alternatively, for a given quantum channel fidelity, the present architecture enables increased secret bit throughput and retroactive validation of entanglement integrity. This advancement is particularly beneficial in satellite-based quantum communication networks, where minimizing classical communication exposure and maximizing secure key rates are essential for operational reliability.

The present disclosure may be characterized by an improved secret key generation rate and enhanced quantum resource efficiency compared to legacy Quantum Key Distribution (QKD) protocols, including for example, Bennett-Brassard 1984 protocol (BB84) and some satellite-based entanglement distribution schemes. The entanglement-cascaded protocol disclosed herein achieves a higher yield of usable secret bits by eliminating the need for classical basis reconciliation and by leveraging conditional operations driven by pre-shared keys. The use of deterministic entanglement swapping and conditional Hadamard operations ensures symmetrical correlation outcomes while minimizing photon wastage and error propagation. As a result, the quantum state operations converge more reliably with lower decoherence-induced failure rates and reduced classical communication overhead. Additionally, device-independent, and retroactive entanglement verification mechanisms significantly improve resistance to intercept-resend and man-in-the-middle attacks, enhancing the security and operational trustworthiness of the present disclosure. The advancement in the present disclosure enables greater key throughput, and improved robustness in long-distance or satellite-based quantum networks and establishes a scalable foundation for future quantum-secure communication infrastructures.

One of ordinary skill in the art will appreciate that techniques consistent with the ongoing description are applicable in other contexts as well without departing from the scope of the ongoing description.

As mentioned above, what is shown and described with respect to the systems and methods above are illustrative. While examples described herein are directed to configurations as shown, it should be appreciated that any of the components described or mentioned herein may be altered, changed, replaced, or modified, in size, shape, and numbers, or material, depending on application or use case, and adjusted for managing handoff.

It should also be appreciated that the systems and methods, as described herein, may also include, or communicate with other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the testing and measurement system.

Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, systems, and methods described herein, and may include volatile and/or non-volatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and interfaces may be any number of mechanical, electrical, hardware, network, or software components, circuits, elements, and interfaces that serves to facilitate communication, exchange, and analysis data between any number of or combination of equipment, protocol layers, or applications. For example, the components described herein may each include a network or communication interface to communicate with other servers, devices, components, or network elements via a network or other communication protocol.

What has been described and illustrated herein are examples of the implementation along with some variations. The terms, descriptions, and figures used herein are set forth by way of illustration only and are not meant as limitations. Many variations are possible within the scope of the implementations, which is intended to be defined by the following claims-and their equivalents-in which all terms are meant in their broadest reasonable sense unless otherwise indicated.

1. A system comprising:
a transmitter communicatively coupled to a processor, wherein the processor is to:
determine a set of communication parameters to be transmitted between the transmitter and a receiver by establishing an initial classical communication channel with the receiver, wherein the set of communication parameters comprise a first secret key, a second secret key, a synchronization sequence, and a predetermined number of quantum particles;
generate at least one entangled pair of qubits comprising at least one first set of qubits and at least one second set of qubits based on the determined set of communication parameters, wherein the at least one first set of qubits correspond to the transmitter and the at least one second set of qubits correspond to the receiver, and wherein each of the set of qubits comprise a first qubit and a second qubit;
perform a first quantum operation associated with the first secret key on each of the second qubits of each of the first set of qubits and the second set of qubits;
swap the second qubit of the transmitter with a second qubit of the receiver upon performing the first quantum operation associated with the first secret key at each of the transmitter and the receiver, wherein the second qubit of the receiver corresponds to the at least one second set of qubits generated by the receiver;
generate entangled qubit pairs by performing a quantum entanglement operation on the first qubit of the transmitter and the second qubit of the receiver, wherein the quantum entanglement operation establishes a maximally entangled bipartite state;
determine at least one quantum measurement operation to be applied to the entangled qubit pairs based on prior measurement results, wherein the at least one quantum measurement operation comprises at least one controlled quantum gate operation;
perform a second quantum operation associated with the second secret key onto the entangled qubit pairs;
iteratively generate at least one measurement result for each of the entangled qubit pairs until the predetermined number of quantum particles are reached, wherein the at least one measurement result is generated by measuring the entangled qubit pairs using the determined at least one quantum measurement operation, wherein the determined at least one quantum measurement operation orientates a state of the entangled qubit pairs to a predefined quantum measurement basis before transmission;
generate a shared classical secret key based on the generated at least one measurement result; and
transmit the generated shared classical secret key from the transmitter to the receiver over a secure communication channel.

2. The system of claim 1, wherein to perform the first quantum operation associated with the first secret key on each of the second qubits of each of the first set of qubits and the second set of qubits, the processor is to:
determine a quantum operation to be applied to the second qubits of each of the first set of qubits and the second set of qubits before performing the at least one quantum measurement operation, wherein the quantum operation comprises one of a controlled-Hadamard gate and a controlled-NOT (CNOT) gate, and wherein the quantum operation further comprises a dynamic phase-shift adjustment determined based on the first secret key; and
conditionally apply the determined quantum operation on each of the second qubits of each of the first set of qubits and the second set of qubits based on a last stored classical measurement results, wherein the determined quantum operation is conditionally applied on each of the second qubits of each of the first set of qubits and the second set of qubits used in a plurality of Quantum Key Distribution (QKD) protocols for an entanglement-cascaded protection.

3. The system of claim 1, wherein to measure the entangled qubit pairs using the determined at least one quantum measurement operation, the processor is to:
perform a sequence of conditional quantum measurement operations on the entangled qubit pairs, wherein each of the measurement operation is performed at a predefined step in the synchronization sequence.

4. The system of claim 1, wherein to iteratively generate the at least one measurement result for each of the entangled qubit pairs until the predetermined number of quantum particles are reached, the processor is to:
perform a quantum state verification process by comparing the generated at least one measurement result with a plurality of prior photon exchanges; and
identify at least one inconsistency in each of the generated at least one measurement result, wherein the at least one inconsistency being indicative of at least one of transmission errors and an external interference.

5. The system of claim 1, wherein to iteratively generate the at least one measurement result for each of the entangled qubit pairs until the predetermined number of quantum particles are reached, the processor is to:
generate at least one synchronization parameter to coordinate sequential quantum exchanges between the transmitter and the receiver;
apply the prior measurement results as conditional inputs for performing subsequent quantum measurement operations on the entangled qubit pairs; and
repeat the process of entanglement, transmission, and measurement operations iteratively until the predetermined number of quantum particles are reached.

6. The system of claim 1, wherein to generate the shared classical secret key based on the generated at least one measurement result, the processor is to:
determine an entanglement cascade sequence of the entangled qubit pairs by dynamically adjusting quantum operations based on prior measurement results;
apply conditional quantum gate operations on the entangled qubit pairs based on the determined entanglement cascade sequence to generate accumulated measurement results; and
generate the shared classical secret key based on the accumulated measurement results.

7. The system of claim 6, wherein to apply the conditional quantum gate operations on the entangled qubit pairs based on the determined entanglement cascade sequence, the processor is to:
dynamically adjust a quantum measurement basis in response to the prior measurement results from prior photon exchanges; and
perform the conditional quantum gate operations using a conditional logic function based on the prior measurement results.

8. The system of claim 1, wherein the at least one quantum measurement operation comprises an operation performed in a defined measurement basis, and wherein the defined measurement basis comprises at least one of an X-basis measurement, a Y-basis measurement, and a Z-basis measurement.

9. The system of claim 1, wherein the receiver is to reconstruct the shared classical secret key by concatenating the prior measurement results based on the communication parameters.

10. The system of claim 1, wherein the processor is further to:
verify completion of the first quantum operation by detecting coherence properties of modified second qubits.

11. A method comprising:
determining, by a processor, a set of communication parameters to be transmitted between a transmitter and a receiver by establishing an initial classical communication channel with the receiver, wherein the set of communication parameters comprise a first secret key, a second secret key, a synchronization sequence, and a predetermined number of quantum particles;
generating, by the processor, at least one entangled pair of qubits comprising at least one first set of qubits and at least one second set of qubits based on the determined set of communication parameters, wherein the at least one first set of qubits correspond to the transmitter and the at least one second set of qubits correspond to the receiver, and wherein each of the set of qubits comprise a first qubit and a second qubit;
performing, by the processor, a first quantum operation associated with the first secret key on each of the second qubits of each of the first set of qubits and the second set of qubits;
swapping, by the processor, the second qubit of the transmitter with a second qubit of the receiver upon performing the first quantum operation associated with the first secret key at each of the transmitter and the receiver, wherein the second qubit of the receiver corresponds to the at least one second set of qubits generated by the receiver;
generating, by the processor, entangled qubit pairs by performing a quantum entanglement operation on the first qubit of the transmitter and the second qubit of the receiver, wherein the quantum entanglement operation establishes a maximally entangled bipartite state;
determining, by the processor, at least one quantum measurement operation to be applied to the entangled qubit pairs based on prior measurement results, wherein the at least one quantum measurement operation comprises at least one controlled quantum gate operation;
performing, by the processor, a second quantum operation associated with the second secret key onto the entangled qubit pairs;
iteratively generating, by the processor, at least one measurement result for each of the entangled qubit pairs until the predetermined number of quantum particles are reached, wherein the at least one measurement result is generated by measuring the entangled qubit pairs using the determined at least one quantum measurement operation, wherein the determined at least one quantum measurement operation orientates a state of the entangled qubit pairs to a predefined quantum measurement basis before transmission;
generating, by the processor, a shared classical secret key based on the generated at least one measurement result; and
transmitting, by the processor, the generated shared classical secret key from the transmitter to the receiver over a secure communication channel.

12. The method of claim 11, wherein performing the first quantum operation associated with the first secret key on each of the second qubits of each of the first set of qubits and the second set of qubits comprises:
determining, by the processor, a quantum operation to be applied to the second qubits of each of the first set of qubits and the second set of qubits before performing the at least one quantum measurement operation, wherein the quantum operation comprises one of a controlled-Hadamard gate and a controlled-NOT (CNOT) gate, and wherein the quantum operation further comprises a dynamic phase-shift adjustment determined based on the first secret key; and
conditionally applying, by the processor, the determined quantum operation on each of the second qubits of each of the first set of qubits and the second set of qubits based on last stored classical measurement results, wherein the determined quantum operation is conditionally applied on each of the second qubits of each of the first set of qubits and the second set of qubits used in a plurality of Quantum Key Distribution (QKD) protocols for an entanglement-cascaded protection.

13. The method of claim 11, wherein measuring the entangled qubit pairs using the determined at least one quantum measurement operation comprises:
performing, by the processor, a sequence of conditional quantum measurement operations on the entangled qubit pairs, wherein each of the measurement operation is performed at a predefined step in the synchronization sequence.

14. The method of claim 11, wherein iteratively generating the at least one measurement result for each of the entangled qubit pairs until the predetermined number of quantum particles are reached comprises:
performing, by the processor, a quantum state verification process by comparing the generated at least one measurement result with a plurality of prior photon exchanges; and
identifying, by the processor, at least one inconsistency in each of the generated at least one measurement result, wherein the at least one inconsistency being indicative of at least one of transmission errors and an external interference.

15. The method of claim 11, wherein iteratively generating the at least one measurement result for each of the entangled qubit pairs until the predetermined number of quantum particles are reached comprises:
generating, by the processor, at least one synchronization parameter to coordinate sequential quantum exchanges between the transmitter and the receiver;
applying, by the processor, the prior measurement results as conditional inputs for performing subsequent quantum measurement operations on the entangled qubit pairs; and
repeating, by the processor, the process of entanglement, transmission, and measurement operations iteratively until the predetermined number of quantum particles are reached.

16. The method of claim 11, wherein generating the shared classical secret key based on the generated at least one measurement result comprises:
determining, by the processor, an entanglement cascade sequence of the entangled qubit pairs by dynamically adjusting quantum operations based on prior measurement results;
applying, by the processor, conditional quantum gate operations on the entangled qubit pairs based on the determined entanglement cascade sequence to generate accumulated measurement results; and
generating, by the processor, the shared classical secret key based on the accumulated measurement results.

17. The method of claim 16, wherein applying the conditional quantum gate operations on the entangled qubit pairs based on the determined entanglement cascade sequence comprises:
dynamically adjusting, by the processor, a quantum measurement basis in response to the prior measurement results from prior photon exchanges; and
performing, by the processor, the conditional quantum gate operations using a conditional logic function based on the prior measurement results.

18. The method of claim 11, wherein the at least one quantum measurement operation comprises an operation performed in a defined measurement basis, and wherein the defined measurement basis comprises at least one of an X-basis measurement, a Y-basis measurement, and a Z-basis measurement.

19. The method of claim 11, further comprising:
verifying, by the processor, completion of the first quantum operation by detecting coherence properties of modified second qubits.

20. A non-transitory computer-readable medium comprising processor-executable instructions that cause a processor to:
determine a set of communication parameters to be transmitted between the transmitter and a receiver by establishing an initial classical communication channel with the receiver, wherein the set of communication parameters comprise a first secret key, a second secret key, a synchronization sequence, and a predetermined number of quantum particles;
generate at least one entangled pair of qubits comprising at least one first set of qubits and at least one second set of qubits based on the determined set of communication parameters, wherein the at least one first set of qubits correspond to the transmitter and the at least one second set of qubits correspond to the receiver, and wherein each of the set of qubits comprise a first qubit and a second qubit;
perform a first quantum operation associated with the first secret key on each of the second qubits of each of the first set of qubits and the second set of qubits;
swap the second qubit of the transmitter with a second qubit of the receiver upon performing the first quantum operation associated with the first secret key at each of the transmitter and the receiver, wherein the second qubit of the receiver corresponds to the at least one second set of qubits generated by the receiver;
generate entangled qubit pairs by performing a quantum entanglement operation on the first qubit of the transmitter and the second qubit of the receiver, wherein the quantum entanglement operation establishes a maximally entangled bipartite state;
determine at least one quantum measurement operation to be applied to the entangled qubit pairs based on prior measurement results, wherein the at least one quantum measurement operation comprises at least one controlled quantum gate operation;
perform a second quantum operation associated with the second secret key onto the entangled qubit pairs;
iteratively generate at least one measurement result for each of the entangled qubit pairs until the predetermined number of quantum particles are reached, wherein the at least one measurement result is generated by measuring the entangled qubit pairs using the determined at least one quantum measurement operation, wherein the determined at least one quantum measurement operation orientates a state of the entangled qubit pairs to a predefined quantum measurement basis before transmission;
generate a shared classical secret key based on the generated at least one measurement result; and
transmit the generated shared classical secret key from the transmitter to the receiver over a secure communication channel.
